(19) United States
(12) Patent Application Publication
(10) Pub. No.: US 2010/0282733 A1
(43) Pub. Date: Nov. 11, 2010

(54) THERMAL PROCESSING APPARATUS

(76) Inventor: Siaw-Yun Chin, Singapore (SG)

Correspondence Address: NORTH AMERICA INTELLECTUAL PROPERTY CORPORATION, P.O. BOX 506, MERRIFIELD, VA, 22116, US

(21) Appl. No.: 12/435,414

(22) Filed: May 5, 2009

(51) Int. Cl. H05B 1/02; H05B 3/68; F27B 5/14

(52) U.S. Cl. 219/448.12; 392/416; 392/420; 219/444.1

(57) ABSTRACT

A thermal processing apparatus includes a chamber for accommodating a semiconductor wafer and a radiant fitting. The radiant fitting includes a plurality of first radiant sources having a first reflectivity positioned in a center region of the radiant fitting and a plurality of second radiant sources having a second reflectivity. The second reflectivity is larger than the first reflectivity.

### BACKGROUND OF THE INVENTION

1. Field of the Invention

The present invention relates to a thermal processing apparatus, and more particularly to, a thermal processing apparatus able to solve problem of center hot occurred in the heated wafer.

2. Description of the Prior Art

Fabrication of integrated circuits (IC) includes performing different processes such as depositions, photolithography, etchings, and ion implantations upon a wafer in order to obtain desired devices and the IC constructed thereby. Among those processes, thermal processes for film formation, annealing, oxidation, diffusion, sputtering, etching and nitridation are particularly susceptible to temperature. In other words, temperature is one of the most important parameters in the thermal processes.

Recently, as semiconductor products trend toward large scale, high density, and single-wafer processing, method and the relating apparatus of rapid thermal processing (RTP) have become more and more important since RTP is preferable to perform the thermal oxidation (RTO) serving for thin-dielectric growth, the rapid thermal chemical vapor deposition (RTCVD) serving for forming amorphous silicon, silicon oxide, and silicon nitride, and the rapid thermal annealing (RTA) process after ion implantation due to its lower thermal budget.

Please refer to FIGS. 1-2, FIG. 1 is a schematic diagram of a conventional RTP apparatus; and FIG. 2 is a top plane view of a radiant fitting of the RTP apparatus shown in FIG. 1. As shown in FIGS. 1 and 2, a RTP apparatus 100 includes a chamber 102, a wafer loading unit 104, and a radiant fitting 110 positioned above the wafer loading unit 104. The radiant fitting 110 is constructed by a plurality of individual bulbs 112 arranged in a radiance pattern and a plurality of individual sleeves 114. The bulbs 112 are divided into different sets, while on/off and temperature of each set are respectively controlled by a power supply. For instance, bulbs 112a in the center region are controlled by one power supply; and bulbs 112b in the peripheral region are controlled by another one. A conventional sleeve 114 has a surface undergone a gold-plating treatment and thus be able to reflect radiant energy from the corresponding bulb 112 and to condense energy and light. As shown in FIG. 1, a wafer 106 is accommodated on the wafer loading unit 104 and undergoes a thermal treatment such as thermal oxidation by the radiant fitting 110.

Please refer to FIG. 3, which is a curve-line graph depicting thickness of a silicon oxide (SiO) layer formed on the wafer 106 after performing the thermal oxidation in the conventional RTP apparatus 100. In FIG. 3, X-axis represents different radial positions of the wafer 106. The midpoint of the X-axis is numbered as “0”, which means the midpoint of the diameter of the wafer 106. Y-axis represents thickness of the SiO layer formed on the wafer 106. Because reflectivity of the sleeves 104 are identical and the radiant energy is omni-directional, center portion of the wafer 106, which is corresponding to the bulbs 112a in the center region of the radiant fitting 110 absorbs much more radiant energies. Referring to FIG. 3, it is observed that the thickness of the SiO layer grown in the center portion of the wafer 106 is much larger than the thickness of the SiO layer grown in the circumferential portion of the wafer 106. It is conceivable the wafer is not evenly heated. Specifically speaking, the center portion of the wafer 106 receives more heat than the circumferential portion of the wafer 106, and this problem is the so-called center hot.

As mentioned above, RTP technique is widely used in the semiconductor processes, and the temperature applied to the wafer 106 considerably affects the processes and the products such as thickness of the formed layer, profiles of the ion implantation, etc. Therefore, it is important to achieve the requirement for temperature uniformity in the RTP technique.

### SUMMARY OF THE INVENTION

It is therefore a primary objective of the present invention to provide a thermal processing apparatus that is able to solve the problem of center hot.

According to the claimed invention, a thermal processing apparatus is provided. The thermal processing apparatus includes a chamber for accommodating a semiconductor wafer and a radiant fitting. The radiant fitting comprises a plurality of first radiant sources having a first reflectivity and positioned in a center region of the radiant fitting and a plurality of second radiant sources having at least a second reflectivity, the second reflectivity is larger than the first reflectivity.

According to the thermal processing apparatus, the first radiant sources having lower reflectivity are positioned in a center region of the radiant fitting, which corresponds to a center portion of the wafer being heated. Therefore energies radiated to the center portion of the wafer is reduced and thus the problem of center hot occurred in the heated wafer during the thermal process is solved.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a conventional RTP apparatus.

FIG. 2 is a top plane view of a radiant fitting of the conventional RTP apparatus shown in FIG. 1.

FIG. 3 is a curve-line graph depicting thickness of a SiO layer formed on the wafer after performing the thermal oxidation in the conventional RTP apparatus

FIG. 4 is a schematic diagram of a thermal processing apparatus provided by a preferred embodiment of the present invention.

FIG. 5 is a top plane view of a radiant fitting of the thermal processing apparatus provided by the preferred embodiment.

FIG. 6 is a cross-sectional view taken along line A-A′ of FIG. 5.

FIG. 7 is a curve-line graph depicting thickness of SiO layers formed on different wafers after performing the thermal oxidation.

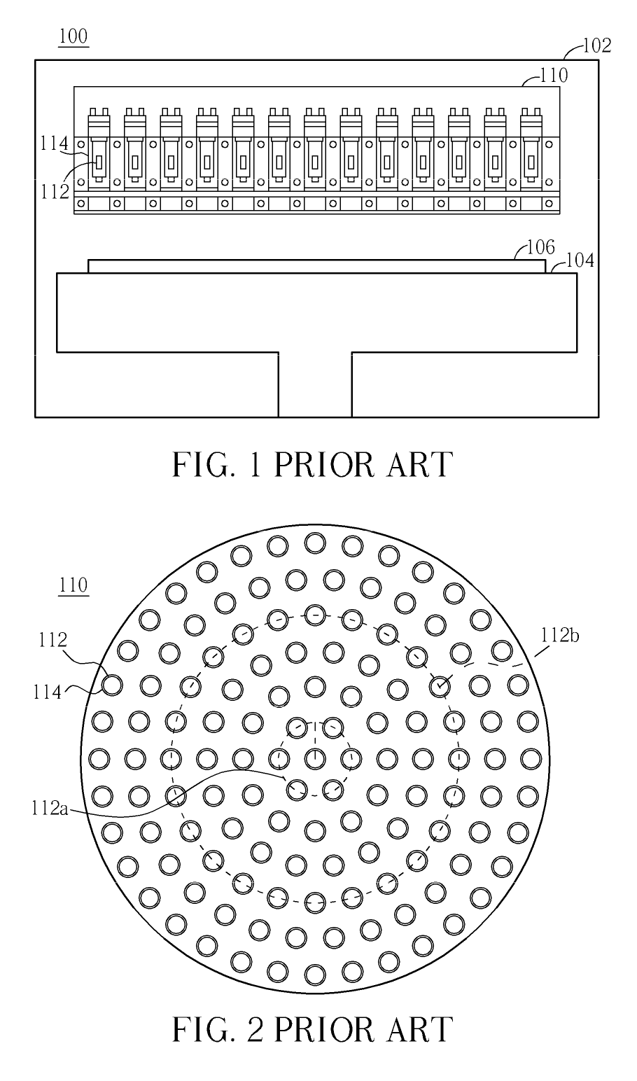

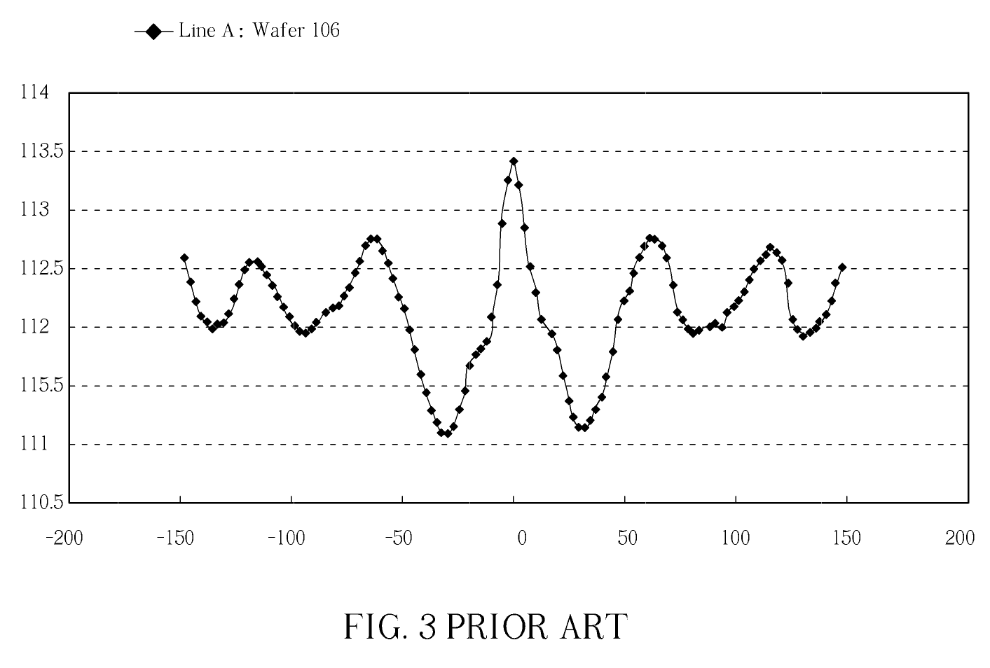

### DETAILED DESCRIPTION

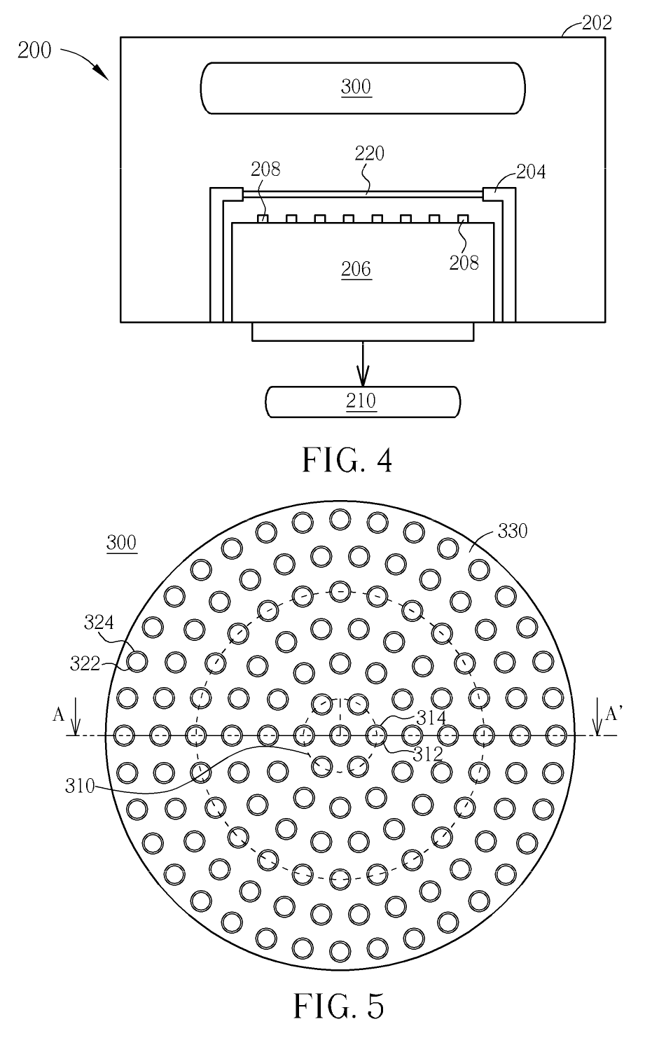

The thermal processing apparatus provided by the present invention exemplarily is a rapid thermal processing (RTP) apparatus, a UV curing system, a physical vapor deposition (PVD) degas apparatus, or a CMP clean bake apparatus. Please refer to FIG. 4, which is a schematic diagram of a thermal processing apparatus provided by a preferred embodiment of the present invention. According to the first embodiment, the provided thermal processing apparatus is a RTP apparatus. As shown in FIG. 4, the thermal processing apparatus 200 comprises a chamber 202 serving for accommodating a semiconductor wafer 220 and a radiant fitting 300. A wafer loading unit 204 is positioned in the chamber 202 for grasping the semiconductor wafer 220. It is well-known to those skilled in the art that thermal conduction discontinuity has been observed if materials adopted in the wafer loading unit 204, particular at the portions contacting with the semiconductor wafer 220, are different from the semiconductor wafer 220. To avoid said adverse influence, portions of the wafer loading unit 204, especially those contacting with the semiconductor wafer 220, are made of material similar with the semiconductor wafer 220. The thermal processing apparatus 200 also comprises a pedestal 206 and a plurality of temperature probes 208 positioned in the pedestal 206. The temperature probes 208 serve to measure temperature of the semiconductor wafer 220. The temperature probes 208 are electrically connected to a controller 210 that is used to receive temperature information provided by the temperature probes 208 and feedback controlling the radiant fitting 300 which includes the first radiant sources 310 and the second radiant sources 320.

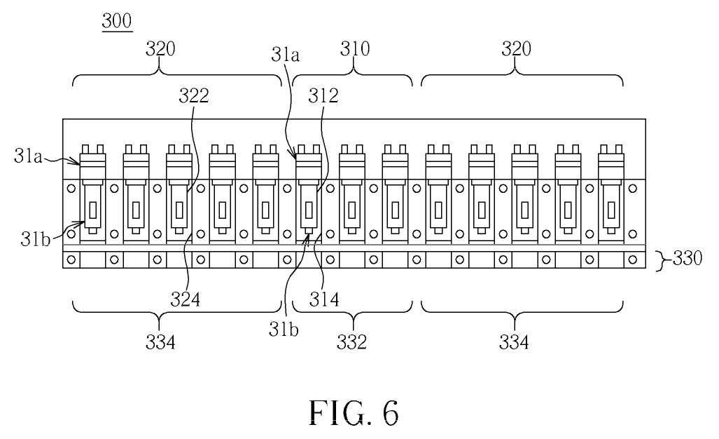

Please refer to FIG. 5-6, FIG. 5 is a top plane view of the radiant fitting 300 of the thermal processing apparatus provided by the present invention; and FIG. 6 is a cross-sectional view taken along line A-A+ of FIG. 5. Those skilled in the art would easily realize that amounts and arrangement of the elements shown in FIGS. 5-6 are adjustable and not limited to this provided embodiment. As shown in FIGS. 5 and 6, the radiant fitting 300 includes a plurality of first radiant sources 310 having a first reflectivity and a plurality of second radiant sources 320 having at least a second reflectivity. It is noteworthy that the second reflectivity is larger than the first reflectivity. The radiant fitting 300 is exemplarily a circular plate. The first radiant sources 310 and the second radiant sources 320 are arranged in concentric-circle radiance pattern with the first radiant sources 310 positioned in a center region of the radiant fitting 300. In other words, during application of the thermal processing apparatus 200, the first radiant sources 310 are corresponding to a center portion of the semiconductor wafer 220 while the second radiant sources 320 arranged in concentric circles are positioned around peripherals of the first radiant sources 310. Each of the first radiant sources 310 and the second radiant sources 320 comprises an individual high-power bulb. The first radiant sources 310 are controlled by one voltage while the second radiant sources 320 are divided into different sets in a concentric circle motif. Each set of the second radiant sources 320 is controlled by one voltage, which means that radiant energies of the second radiant sources 320 in one set are controlled by the one voltage.

Please refer to FIG. 6. The second radiant source 320 comprises a second bulb 322. The second bulb 322 has a metal surface obtained by a surface treatment and thus possesses the second reflectivity. In the preferred embodiment, the metal surface includes gold and is obtained by gold-plating treatment. The first radiant source 310 includes a first bulb 312 having the first reflectivity. The first bulb 312 can possess a metal surface. It is noteworthy that the reflectivity of the metal used in the first bulb 312 is smaller than that of the metal used in the second bulb 322. In this preferred embodiment, the reflectivity of the metal surface of the first bulb 312 is smaller than gold. And thus the first reflectivity of the first radiant source 310 is smaller than the second reflectivity of the second radiant source 230. The first bulb 312 can also possess a metal-oxide surface, and the metal oxide can be any metal oxide having a reflectivity smaller than the metal used in the second bulb 322. However, the metal oxide surface of the first bulb 312 preferably includes a metal oxide of the metal used in the second bulb 322 such as aurum oxide. And thus the first reflectivity of the first radiant source 310 is smaller than the second reflectivity of the second radiant source 320. Additionally, whether the surface of the first bulb 312 includes metal or metal oxide, it can be a rough surface while the surface of the second bulb 322 is a smooth surface. Consequently, the first reflectivity of the first radiant source 310 is made even smaller than the second reflectivity of the second radiant source 320.

Please refer to FIG. 6 again. The first radiant source 310 further includes a first sleeve 314 and the second radiant source 320 further includes a second sleeve 324, the first sleeve 314 and the second sleeve 324 respectively corresponds to the first bulb 312 and the second bulb 314. The second sleeve 324 possesses a metal surface. As described afore, the metal surface of the second sleeve 324 includes gold, and is obtained by a gold-plating treatment. The first sleeve 314 can possess a metal surface. It is noteworthy that the reflectivity of the metal used in the first sleeve 314 is smaller than that of the metal material used in the second sleeve 324. In this preferred embodiment, the reflectivity of the metal used in the first sleeve 314 is smaller than gold. The first sleeve 314 can also possess a metal oxide surface, and the metal oxide can be any metal oxide that has a reflectivity smaller than the metal used in the second sleeve 324. The metal oxide used in the first sleeve 314 preferably is a metal oxide of the metal used in the second sleeve 324 such as aurum oxide. Thus the first reflectivity of the first radiant source 310 is smaller than the second reflectivity of the second radiant source 320. Additionally, whether the surface of the first sleeve 314 includes metal or metal oxide, it can be a rough surface while the surface of the second sleeve 324 is a smooth surface. Accordingly, the first reflectivity of the first radiant source 310 is made even smaller than the second reflectivity of the second radiant source 320.

Please still refer to FIGS. 5 and 6. Both of the first bulb 312 and the second bulb 314 comprise a power end 31a and a radiance-emitting end 31b. The power end 31a and the radiance-emitting end 31b of the first bulb 312 and the second bulb 314 are positioned in the radiant fitting 300 along a first direction. And the first direction is perpendicular to a surface of the semiconductor wafer 220. According to the preferred embodiment, the radiant fitting 300 further includes a screen 330 positioned on the radiant fitting 300 on a side that the first radiant sources 310 and the second radiant sources 320 facing to the semiconductor wafer 220. As shown in FIG. 5, the screen 330 comprises a hive pattern or a concentric circles pattern for exposing the first radiant sources 310 and the second radiant sources 320. The screen 330 includes a first region 332 corresponding to the first radiant sources 310 and a second region 334 corresponding to the second radiant source 320. The second region 334 possesses a metal surface, and the first region 332 can possess a metal surface. A reflectivity of the metal used in the first region 332 is smaller than that of the metal used in the second region 334. The first region 332 can also possess a metal oxide surface and the metal oxide can be any metal oxide that has a reflectivity smaller than the metal used in the second region 334. However, the metal oxide used in the first region 332 preferably is a metal oxide of the metal used in the second region 334. Additionally, whether the surface of the first region 332 includes metal or metal oxide, it can be a rough surface while the surface of the second region 334 is a smooth surface. Thus the first reflectivity of the first radiant source 310 is made even smaller that the second reflectivity of the second radiant source 320.

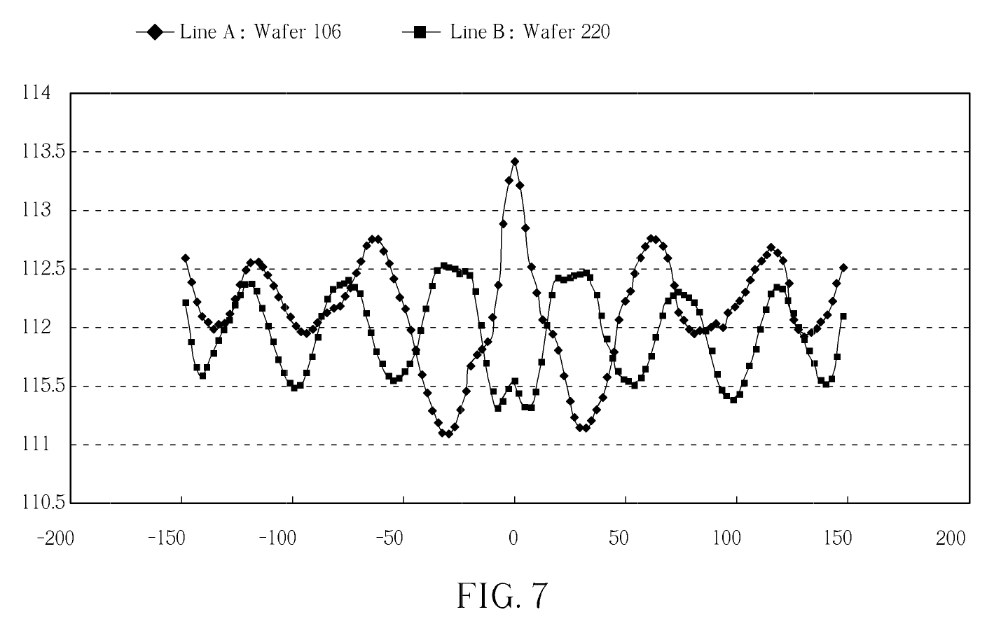

Please refer to FIG. 7, which is a curve-line graph depicting thickness of SiO layers formed on different wafers after performing the thermal oxidation. For illustrating advantages of the thermal processing apparatus 300 provided by the present invention, the wafer 106 that undergoes the thermal oxidation in the conventional RTP apparatus is shown in FIG. 7 as a comparison. As shown in FIG. 7, the wafer 106 that undergoes the thermal oxidation in the conventional RTP apparatus is recorded as line A; and the wafer 220 that undergoes the thermal oxidation in the thermal processing apparatus provided by the present invention is recoded as line B. According to the present disclosure, the thermal processing apparatus 200 includes different radiant sources having difference reflectivity. Specifically, first reflectivity of the first radiant source 310 that corresponding to the center portion of the semiconductor wafer 220 is smaller because the surface of the first bulb 312 and/or the first sleeve 314 includes metal or metal oxide that has smaller reflectivity. The metal or metal oxide surface of the first bulb 312 or first sleeve 314 can be a rough surface thus makes the first reflectivity of the first radiant source 310 even smaller than the second reflectivity of the second radiant source 320. As shown in FIG. 7, since the reflectivity of the first radiant source 310 is reduced, the energies provided by the first radiant source 310 are consequently reduced. Therefore it is observed that the thickness of the SiO layer grown in the center portion of the semiconductor wafer 220 is apparently smaller than that of the semiconductor wafer 106. In other words, the problem of center hot occurred in the heated wafer during the thermal process is solved according to the thermal processing apparatus 200 provided by the present invention.

According to the thermal processing apparatus provided by the present invention, the first radiant sources having lower reflectivity are positioned in a center region of the radiant fitting, which corresponds to a center portion of the semiconductor wafer. Therefore energies radiated to the center portion of the wafer being heated is reduced and thus the problem of center hot occurred in the heated wafer during the thermal process is solved. On another hand, the thermal processing apparatus provided by the present invention satisfies the requirement for temperature uniformity. It further improves the thermal processing apparatus and qualities of its products without the expensive alteration upon the arrangement of the radiant sources.

Those skilled in the art will readily observe that numerous modifications and alterations of the device and method may be made while retaining the teachings of the invention.

What is claimed is:

1. A thermal processing apparatus comprising:
a chamber for accommodating a semiconductor wafer; and
a radiant fitting comprising:
a plurality of first radiant sources having a first reflectivity and positioned in a center region of the radiant fitting; and
a plurality of second radiant sources having at least a second reflectivity, the second reflectivity is larger than the first reflectivity.

2. The thermal processing apparatus of claim 1, wherein the first radiant sources and the second radiant sources are arranged in a radiance pattern.

3. The thermal processing apparatus of claim 1, wherein the first radiant sources comprise at least a first bulb and a first sleeve corresponding to the first bulb, and the second radiant sources comprise a plurality of second bulbs and a plurality of second sleeves respectively corresponding to the second bulbs.

4. The thermal processing apparatus of claim 3, wherein the first bulb and the second bulbs respectively possesses the first reflectivity and the second reflectivity.

5. The thermal processing apparatus of claim 4, wherein the second bulb comprises a metal surface, and the metal comprises gold.

6. The thermal processing apparatus of claim 5, wherein the first bulb comprises a metal surface, and a reflectivity of the metal is smaller than gold.

7. The thermal processing apparatus of claim 3, wherein the first bulb comprises a metal oxide surface.

8. The thermal processing apparatus of claim 7, wherein the metal oxide comprises aurum oxide.

9. The thermal processing apparatus of claim 3, wherein the first bulb comprises a rough surface.

10. The thermal processing apparatus of claim 3, wherein the first sleeve and the second sleeves respectively possesses the first reflectivity and the second reflectivity.

11. The thermal processing apparatus of claim 10, wherein the second sleeve comprises a metal surface, and the metal comprises gold.

12. The thermal processing apparatus of claim 11, wherein the first sleeve comprises a metal surface, and a reflectivity of the metal is smaller than gold.

13. The thermal processing apparatus of claim 10, wherein the first sleeve comprises a metal oxide surface.

14. The thermal processing apparatus of claim 13, wherein the metal oxide comprises aurum oxide.

15. The thermal processing apparatus of claim 10, wherein the first sleeve comprises a rough surface.

16. The thermal processing apparatus of claim 1, wherein the radiant fitting further comprises a screen positioned on the radiant fitting on a side that the first radiant sources and the second radiant sources facing to the semiconductor wafer.

17. The thermal processing apparatus of claim 16, wherein the screen comprises a hive pattern or a concentric circles pattern for exposing the first radiant sources and the second radiant sources.

18. The thermal processing apparatus of claim 1 further comprises a plurality of temperature probes for detecting temperatures of the semiconductor wafer.

19. The thermal processing apparatus of claim 18 further comprises a controller electrically connected to the temperature probes for receiving temperature information provided by the temperature probes and feedback controlling the first radiant sources and the second radiant sources.

20. The thermal processing apparatus of claim 1, wherein the thermal processing apparatus is a rapid thermal processing (RTP) apparatus, a UV curing system, a physical vapor deposition (PVD) degas apparatus, or a CMP clean bake apparatus.
